(19) United States
(12) Patent Application Publication
(10) Pub. No.: US 2021/0189756 A1
(43) Pub. Date: Jun. 24, 2021

(54) COMBINATION TENT AND TRAILER ASSEMBLY

(71) Applicant: U-ASV, LLC, Shawnee, OK (US)

(72) Inventor: Donald R. Newton, Shawnee, OK (US)

(21) Appl. No.: 17/265,712

(22) PCT Filed: Aug. 29, 2019
(86) PCT No.: PCT/US19/48843

§ 371 Date: Feb. 3, 2021

Related U.S. Application Data
(60) Provisional application No. 62/724,415, filed on Aug. 29, 2018.

(51) Int. Cl. E04H 15/08; E04H 15/48; B60P 3/34

(52) U.S. Cl. CPC E04H 15/08; B60P 3/341; E04H 15/48

(57) ABSTRACT

A tent assembly including a trailer, a support structure attached to the trailer, and a canvas connected to the support structure. The trailer has a first sidewall, a second sidewall, and a floor extending between the first and second sidewalls. The floor has a loading end and a hitching end. The support structure includes a first support base positioned on the first sidewall, a second support base positioned on the second side wall, and a plurality of support members extending from the first support base to the second support base. The support members are movable between a collapsed position adjacent the hitching end to provide a loading space at the loading end, and an open position where the plurality of support members are in a spaced apart relationship to support the canvas and form an enclosure over the floor of the trailer.

### INCORPORATION BY REFERENCE

The present patent application hereby incorporates by reference the entire provisional patent application identified by U.S. Ser. No. 62/724,415, which was filed on Aug. 29, 2019.

### BACKGROUND

The inventive concepts disclosed herein relate generally to a camping or utility trailer, and more specifically, but not by way of limitation, to tent assembly for a camping or utility trailer.

On camping trips or other outdoor activities, it is often desirable for the persons camping to utilize a camping trailer which is essentially a self-contained unit which may be used for shelter and storage. Such a trailer provides a mobile camp site which may be left in place when the campers' vehicle is moved. Camping trailers typically provide more amenities than a simple tent—for example, an elevated floor above the ground surface.

A camping trailer typically includes a rigid body and a tent-like canvas canopy which is supported above the body to form an enclosure. When the camping trailer is not being used, the canopy is folded inside of the trailer body. However, folding the canopy inside the trailer can interfere with loading and unloading recreational vehicles and other items onto and off of the trailer. Popup campers, a type of camping trailer, can be collapsed for storage and transport comprised of a trailer frame, a box, a hard roof, and soft walls. However, popup campers cannot be used to transport equipment or vehicles, such as all-terrain vehicles (ATVs) because they are folded upon the trailer during transport.

Unlike popup campers, some camping trailers do provide cargo space during transport. However, the amount of space for living quarters on such camping trailers is limited because the cargo space occupies a significant portion of the trailer when the camping trailer is not in transport and the shelter is erected.

Thus, there is a need for combination tent and trailer assembly that when the tent collapsed for storing is positioned outside the confines of the interior of the trailer to provide an open space for loading and unloading, and an assembly that provides cargo space during transport but also maximizes living space when the tent is erected

### BRIEF DESCRIPTION OF THE DRAWINGS

Like reference numerals in the figures represent and refer to the same or similar element or function. Embodiments of the present disclosure may be better understood when consideration is given to the following detailed description thereof. Such description makes reference to the annexed pictorial illustrations, schematics, graphs, drawings, and appendices. In the drawings:

FIG. 1 is a side elevation view of a combination tent and trailer assembly shown in an open position.

FIG. 2 is a side elevation view of the combination tent and trailer assembly of FIG. 1 showing a support structure.

FIG. 3 is a top plan view of the combination tent and trailer assembly shown in the closed position.

FIG. 4 is a side elevation view of the combination tent and trailer assembly shown in a closed position.

FIG. 5 is a partial side elevation view of a support structure and a canvas.

FIG. 6 is a side elevation view of the combination tent and trailer assembly shown in a closed position with a cover covering the support structure.

FIG. 7 is a front perspective view of the combination tent and camping trailer assembly shown in the closed position.

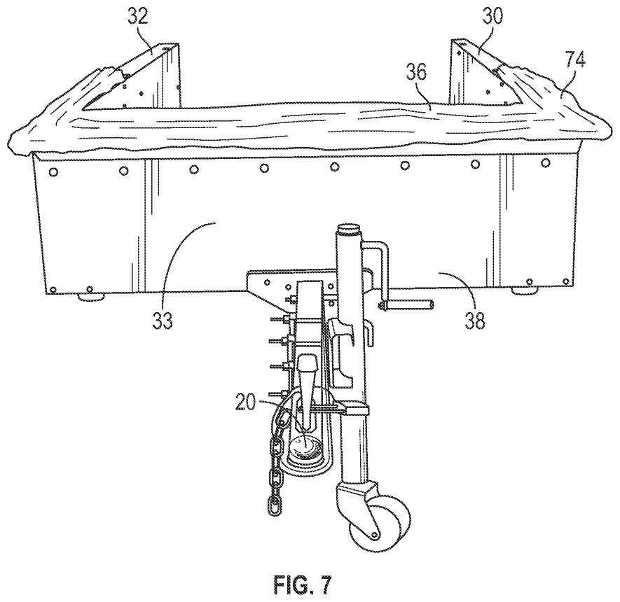

FIG. 8 is a side elevation view of the combination tent and camping trailer assembly with a ramp shown in an open position forming a porch surface.

FIG. 9 is a side elevation view of another version of a combination tent and trailer assembly constructed in accordance with the present disclosure and shown in an open position.

FIG. 10 is a side elevation view of the combination tent and trailer assembly of FIG. 9 shown in a closed position.

FIG. 11 is a side elevation view of the combination tent and trailer assembly showing a support structure.

FIG. 12 is a partial top plan view of the combination tent and trailer assembly showing the support structure in the closed position.

FIG. 13 is a rear elevation view of the combination tent and trailer assembly of FIG. 9 showing the support structure in an open position.

FIG. 14 is a side elevation, exploded view of a sidewall of a trailer with the supporting structure in a closed position.

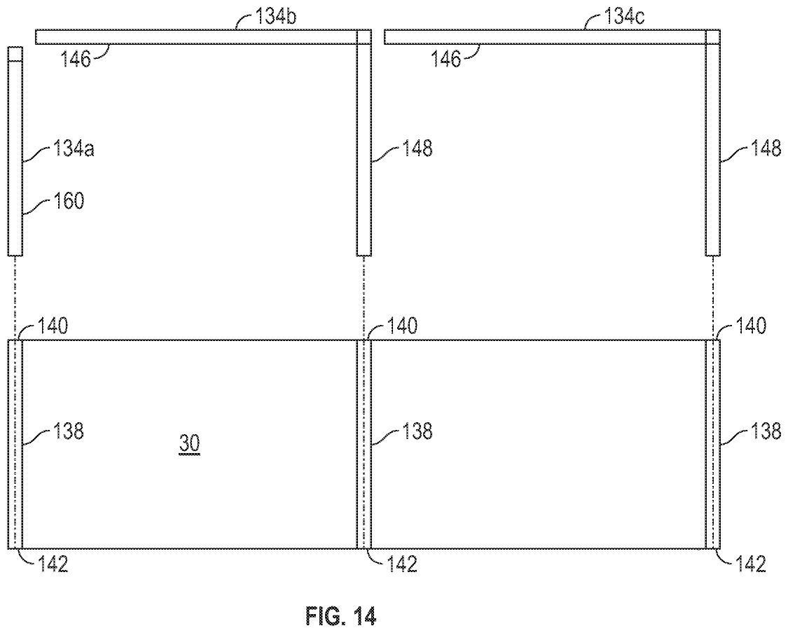

### DETAILED DESCRIPTION OF EXEMPLARY EMBODIMENTS

Before explaining at least one embodiment of the present disclosure in detail, it is to be understood that embodiments of the present disclosure are not limited in their application to the details of construction and the arrangement of the components or steps or methodologies set forth in the following description or illustrated in the drawings. The inventive concepts in the present disclosure are capable of other embodiments or of being practiced or carried out in various ways. Also, it is to be understood that the phraseology and terminology employed herein is for the purpose of description and should not be regarded as limiting.

In this detailed description of embodiments of the inventive concepts, numerous specific details are set forth in order to provide a more thorough understanding of the inventive concepts. However, it will be apparent to one of ordinary skill in the art that the inventive concepts disclosed and claimed herein may be practiced without these specific details. In other instances, well-known features have not been described in detail to avoid unnecessarily complicating the instant disclosure.

As used herein, language such as “including,” “comprising,” “having,” “containing,” or “involving,” and variations thereof, is intended to be broad and encompass the subject matter listed thereafter, equivalents, and additional subject matter not recited or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Throughout this disclosure and the claims, the terms “about,” “approximately,” and “substantially” are intended to signify that the item being qualified is not limited to the exact value specified, but includes slight variations or deviations therefrom, caused by measuring error, manufacturing tolerances, stress exerted on various parts, wear and tear, or combinations thereof, for example.

The use of the term “at least one” will be understood to include one and any quantity more than one, including but not limited to each of, 2, 3, 4, 5, 10, 15, 20, 30, 40, 50, 100, and all integers therebetween. The term “at least one” may extend up to 100 or 1000 or more, depending on the term to which it is attached; in addition, the quantities of 100/1000 are not to be considered limiting, as higher limits may also produce satisfactory results. Singular terms shall include pluralities and plural terms shall include the singular unless indicated otherwise.

The term “or combinations thereof” as used herein refers to all permutations and/or combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Finally, as used herein any reference to “one embodiment” or “an embodiment” means that a particular element, feature, structure, or characteristic described in the embodiment is included in at least one embodiment. The appearances of the phrase “in one embodiment” in various places in the specification are not necessarily referring to the same embodiment, although the inventive concepts disclosed herein are intended to encompass all combinations and permutations including one or more features of the embodiments described.

As discussed above, popup camping trailers are known in the art. However, known camping trailers with collapsible shelters require the shelter to be placed inside the confines of the trailer when stored—thereby interfering with the loading and unloading of the trailer and possibly eliminating cargo space during travel. Those camping trailers having cargo space have limited living space because the cargo area occupies part of the trailer while the living area is made available. As will be described below, the present disclosure solves these problems by providing a collapsible shelter having an open loading area when the shelter or tent is in the collapsed position and also maximizes the amount of living space on the trailer when the shelter or tent is in the open or operable position.

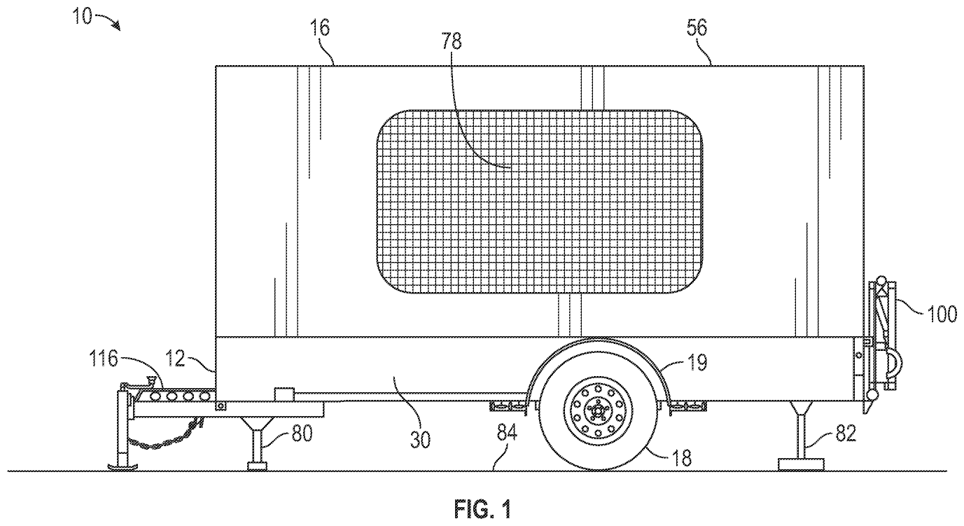

Referring now to FIGS. 1-4, shown therein is a combination tent and trailer assembly 10 according to the present disclosure. The tent assembly 10 includes a trailer 12, a support structure 14 connected to the trailer 12, and a canvas 16 attached to the support structure 14. The support structure 14 and the canvas 16 cooperate to form a shelter or tent over the trailer 12. When not in use, the support structure 14 and canvas 16 may be collapsed for travel and/or storage—providing an open space for loading and unloading items onto and off of the trailer 12.

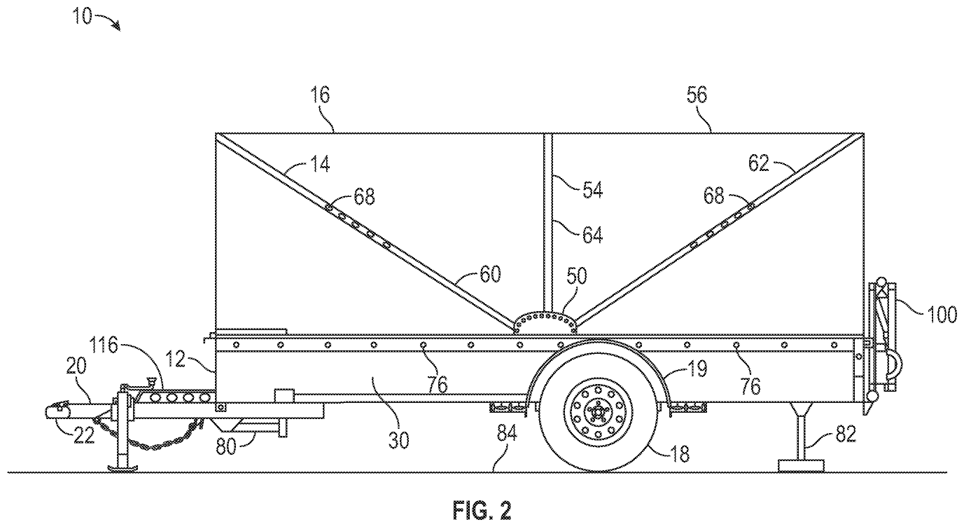

A variety of trailers may be used with the assembly 10. For example, but not by way of limitation, as shown in FIG. 2, the trailer 12 may be a flatbed trailer having one or more axle, a pair of wheels 18 connected to each axle, and a plurality of fenders 19 with each fender 19 extending over at least one of the wheels 18. In some instances, each fender 19 may extend over two or more of the wheels 18. The trailer 12 may be connectable to any suitable vehicle (not shown) for towing the trailer 12 to a desired camping location. The trailer 12 may be attached to a vehicle using a hitch 20. A person having ordinary skill in the art will appreciate the various mechanisms available for attaching the trailer 12 to a vehicle. For example, but not by way of limitation, a ball (not shown) may be mounted to the rear of the tow vehicle and a coupler 22 may be attached to a hitching end of the trailer 12 for receiving the ball.

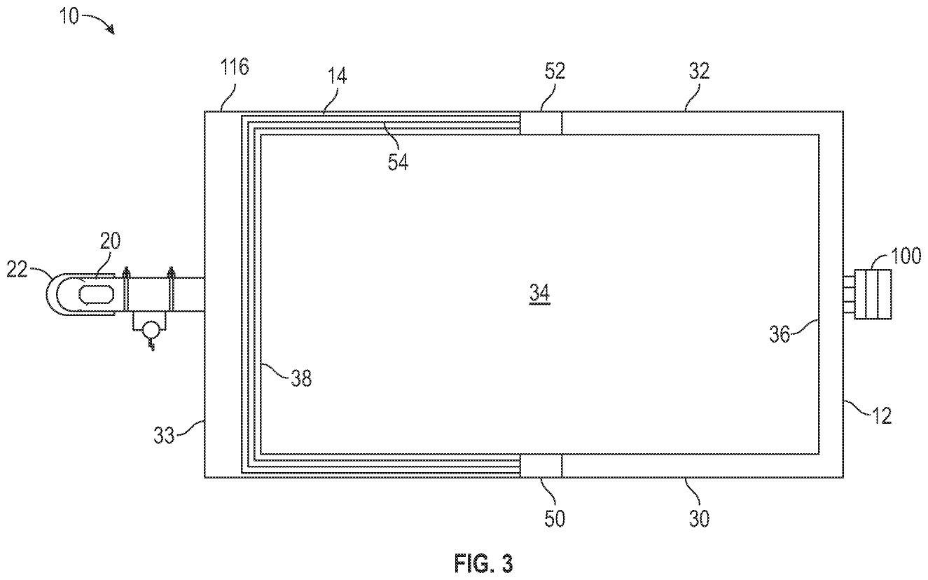

As best shown in FIG. 3, the trailer 12 includes a first sidewall 30, a second sidewall 32, a front wall 33, and a trailer floor 34 extending between the first sidewall 30 and the second sidewall 32. The trailer floor 34 includes a loading end 36 and a hitching end 38. When the trailer 12 is being towed by a vehicle, the hitching end 38 is adjacent the towing vehicle. Camping equipment and ATVs, for example, may be loaded at the loading end 36. The trailer 12 may have a length, but is not limited to having a length, between about 8.0 feet and about 14.0 feet. The trailer 12 may be positioned between about 14.0 and about 18.0 inches above a ground level. The first sidewall 30 and the second sidewall 32 may have any height to assist in maintaining an item within the trailer 12. For example, the first sidewall 30, the second sidewall 32, and the front wall 33 may have, but are not limited to having, a height between about 10.0 inches and about 36.0 inches above the trailer floor 34. In one embodiment, the first and second sidewalls 30 and 32, and the front wall 33 have a height of about 16⅝ inches.

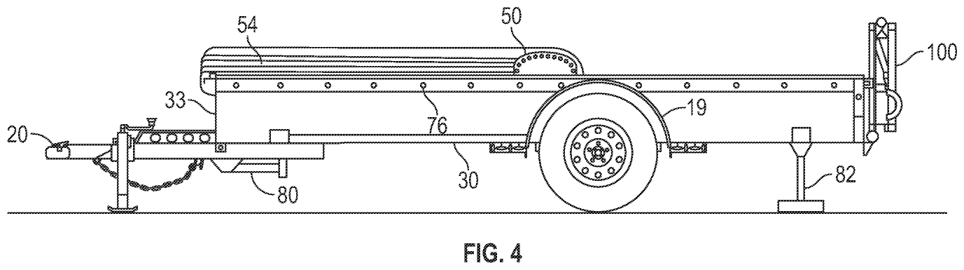

The support structure 14 is connected to the first sidewall 30 and the second sidewall 32. In some embodiments, the support structure 14 is adjacent to the first sidewall 30 and the second sidewall 32. For instance, the support structure 14 may be connected to the trailer floor 34, a frame (not shown) of the trailer 12, or to a pair of the fenders 19. The support structure 14 includes a first support base 50 positioned on the first sidewall 30 and a second support base 52 positioned on the second sidewall 32. The support structure 14 further includes a plurality of support members 54 extending from the first support base 50 to the second support base 52. The canvas 16 is attached to the plurality of support members 54. The plurality of support members 54 are movable between a collapsed position (shown in FIGS. 3 and 4) adjacent the hitching end 38 to provide an open loading space at the loading end 36, and an open position (shown in FIGS. 1-2) where the plurality of support members 54 are in a spaced apart relationship to support the canvas 16 over the trailer floor 34 of the trailer 12. When the support members 54 are in the collapsed position, the support members 54 do not interfere with the loading of items including, but not limited to, ATVs and other recreational or camping equipment.

In one embodiment, best shown in FIG. 2, the plurality of support members 54 includes a first support member 60, a second support member 62, and a third support member 64 positioned between the first support member 60 and the second support member 62. In this embodiment, the length of the first support member 60 is equal to the length of the second support member 62, and the length of the third support member 64 is less than the lengths of the first support member 60 and the second support member 62 so that the canvas 16 is supported in a substantially rectangular shape above the trailer floor 34. It should be appreciated, however, that the support members 54 may be formed of various lengths to support the canvas 16 in various shapes above the trailer floor 34. For example, but not by way of limitation, in another embodiment, (not shown) the plurality of support members 54 includes a first support member, a second support member, and third support member, wherein each of the first, second, and third support members have equal lengths so that the canvas 16 is supported in a substantially semi-spherical shape above the trailer floor 34.

The support structure 14 may be formed from a variety of rigid materials. For example, but not by way of limitation, the support members 54 may be formed of extruded aluminum. The support structure 14 may be attached to the first and second sidewalls 30 and 32, or the front wall 33 by a variety of means including, but not limited to, bolts, screws, and/or welding. The support structure 14 may also be integrated into the sidewalls 30 and 32. The support structure 14 may be attached to the trailer floor 34. The support members 54 may be, but are not limited to being, between about 1.0 and about 3.0 inches thick.

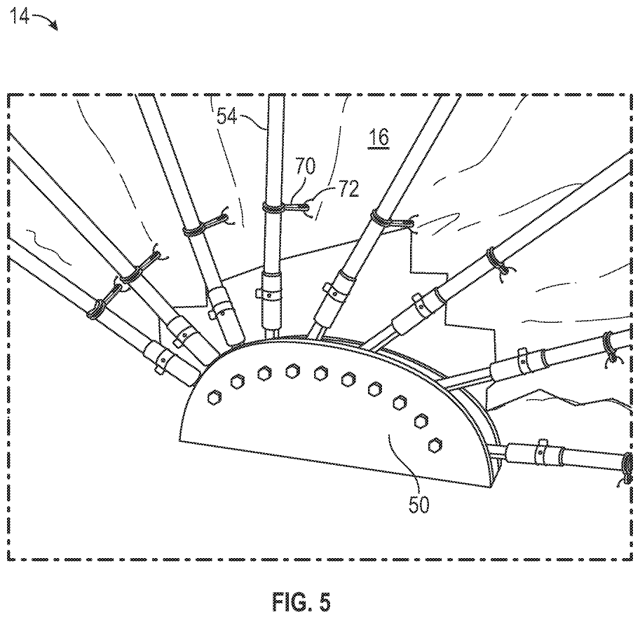

As shown in FIG. 2, the canvas 16 may be attached to the support members 54 by a variety of means known in the art, including by using attachments, such as connecting members 68. For example, but not by way of limitation, as shown in FIG. 5, the support members 54 may include a plurality of attachment members or hooks 70 for attaching to a plurality of loops 72 positioned on the canvas 16. The spacing of the loops 72 on the canvas 16 corresponds with the positioning of the support members 54 when the support structure 14 is in the open position. In another embodiment (now shown), the canvas 16 includes a plurality of slots or sleeves for receiving each of the plurality of support members 54. It should be appreciated that other means for connecting the canvas to the support members 54 may be used including, but not limited to, Velcro® products and straps. The connections between the canvas 16 and the support members 54 may extend continuously throughout substantially the entire lengths of the support members 54 or may extend partial lengths of the support members 54 and may be of a semi-permanent type, so that the canvas 16 and the support members 54 can be separated if desired.

As shown in FIG. 2, the connecting members 68 are arranged on support members 54 so that the support members 54 constitute an external skeleton or rigid supporting structure from which the canvas 16 is suspended. This arrangement of support members 54 and the canvas 16 which form the walls and roof of the enclosure over the trailer floor 34 is such that the enclosure or shelter may be collapsed and opened much like a top to a convertible car or a fan—since all or most of the parts are secured together in both the collapsed and open position. Assembly is, therefore, simple and rapid. When the support members 54 are in an open position, the canvas 16 may be attached to the first sidewall 30 and the second sidewall 32 by a plurality of attachment members 76. The attachment members 76 may be any known suitable mechanism including, but not limited to, snaps, Velcro® hook and loop, and ties.

The canvas 16 may be made of a variety of materials including, but not limited to, flexible woven fabric made of cotton, nylon, hyfrofilm, outtex, polyester, or some other type of natural or synthetic material known in the art. The canvas may also include patterns, such as camouflage. The canvas 16 may further include screened window cut outs, such as windows 78, shown in FIG. 1. The canvas 16 may further include zip out openings, clear vinyl moonroof(s), tinted vinyl window(s), camouflage removeable hunting shoot through screen(s), or non screened window cut outs. The attachments of said canvas 16 for openings and/or screens may be attached by various means known in the art such as Velcro, zippers, snaps or the like. The openings or cut outs for the canvas 16 may be in any combination, shape, location or orientation such as 360 degrees. The canvas 16 may contain opening(s) for electric cords such as E-port. These openings may be in any location or orientation. The canvas 16 may also incorporate or have attached netting or pockets in any location or orientation to store gear or personal belongings. The canvas 16 may have a screened opening with covered weather flap to allow external heat and/or an air unit to maintain comfort for occupants.

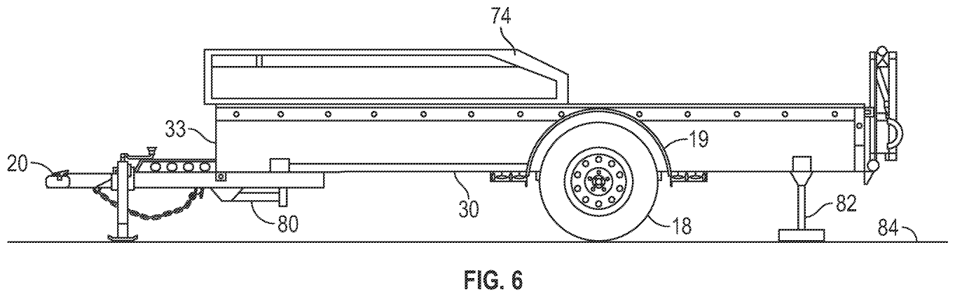

As best shown in FIG. 6, when the support members 54 are in the closed position, the support structure 14 may be covered with a cover 74. The cover 74 allows the user to protect the support structure 14 and helps stabilize the support structure 14 during travel. The cover 74 may remain attached to the trailer 12 when not used to keep the cover 74 from getting lost. When the support members 54 are in the open position, the cover 74 may be placed inside or outside the trailer 12. It should be appreciated, however, that the cover may also be removable from the trailer 12. The cover may be formed of a soft or rigid material.

The trailer 12 may include a first jack 80 extending from the trailer floor 34 of the trailer 12 and adjacent the hitching end 38. The first jack 80 may move between a stored position (shown in FIG. 2) and an operable position (shown in FIG. 1). The trailer 12 may include two or more first jacks 80 adjacent to the hitching end 38. The trailer 12 may also include a second jack 82 adjacent the loading end 36, also moveable between a stored and operable position. The trailer 12 may include two or more first jacks 80 adjacent to the hitching end 38. When the first or second jack 80/82 is in the operable position, the first or second jack 80 or 82 extends from the trailer floor 34 towards a ground surface 84. The first and second jack 80/82 may help stabilize the trailer 12 when used as a camping shelter so that users can move from one end of the trailer floor 34 to another without the trailer 12 tipping.

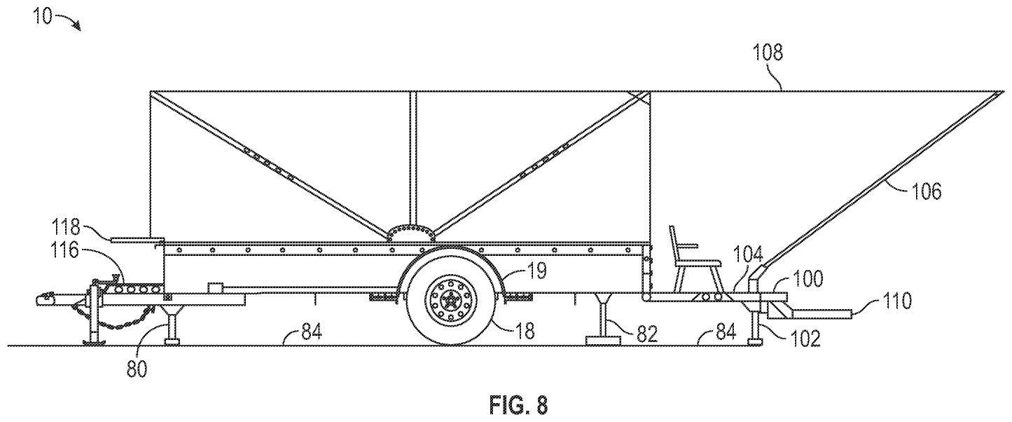

As shown in FIGS. 1-3 and 8, the trailer 12 may include a storage rack 116. The storage rack 116 may be used for storing various items including, but not limited to, air conditioning units, propane tanks, and generators. The storage rack 116 may also contain D-ring tie downs in various locations, orientation(s) or combination to secure items. The D-ring tie downs may be attached to the trailer floor 34, for example. As shown in FIGS. 2 and 8, the trailer 12 may also include a folding shelf 118 extending from the hitching end 38. The folding shelf 118 is movable between a stored position and an open position for supporting an air conditioning unit. The canvas 16 may include a re-sealable opening for receiving the air conditioning unit positioned on the folding shelf 118.

In one embodiment, best shown in FIG. 8, the tent assembly 10 includes a ramp 100 extending from the loading end 36 of the trailer 12. The ramp 100 is movable between a storage position (shown in FIGS. 2, 4, and 6) and an operable position (shown in FIG. 8). When the ramp 100 is in the operable position, the ramp 100 may be supported by a stabilizing member 102 extending from the ramp 100 towards the ground surface 84 to provide a porch surface 104. The ramp 100 may be, but is not limited to being a double fold ramp. Further, the ramp and/or gate at the loading end may be made from a variety of material such as steel or variety of appearance such as mesh or solid well known in the art. A plurality of rods 106 may extend from the porch surface 104 to support a canopy 108 extending from the support structure 14 in order to provide a cover over the porch surface 104. A fold over step 110 may extend from the ramp 100 for more easily accessing the porch surface 104.

To form the tent assembly 10, the trailer 12 is obtained, and the support structure 14 may be connected to the first sidewall 30 and the second sidewall 32. The canvas 16 may be supported by the front wall 33 on the hitching end 38. The canvas 16 may be attached to the plurality of support members 54. The plurality of support members 54, and the canvas 16 attached to the support members 54 are movable between the collapsed position adjacent to the hitching end 38 to provide a loading space at the loading end 36, and an open position where the plurality of support members 54 are in a spaced apart relationship to support the canvas 16 and form an enclosure over the trailer floor 34 of the trailer 12. In some embodiments, the canvas 16 and the support members 54 are positioned at the loading end 36 in the collapsed position.

The tent can be formed by extending a plurality of support members 54 of the support structure 14 from the collapsed position adjacent to the hitching end 38 of the trailer 12 to an open position where the plurality of support members 54 are in a spaced apart relationship to form the tent support extending across the trailer floor 34 of the trailer 12 between the hitching end 38 and the loading end 36 of the trailer 12. The canvas 16 can be attached to certain ones of the plurality of support members 54 before or after the plurality of support members 54 are extended. When the canvas 16 is attached to the support members 54 prior to the support members 54 being extended, extending the support members 54 forms the tent. When the canvas 16 is attached to the support members 54 after the support members 54 are extended, attaching the canvas 16 to the support members 54 forms the tent.

Further, the ramp 100 can be extended from the loading end 36 of the trailer 12 to the operable position, the ramp 100 being movable between the storage position and the operable position. Then, one or more stabilizing member 102 can be extended from the ramp 100 towards the ground surface 84 such that the ramp 100 provides the porch surface 104.

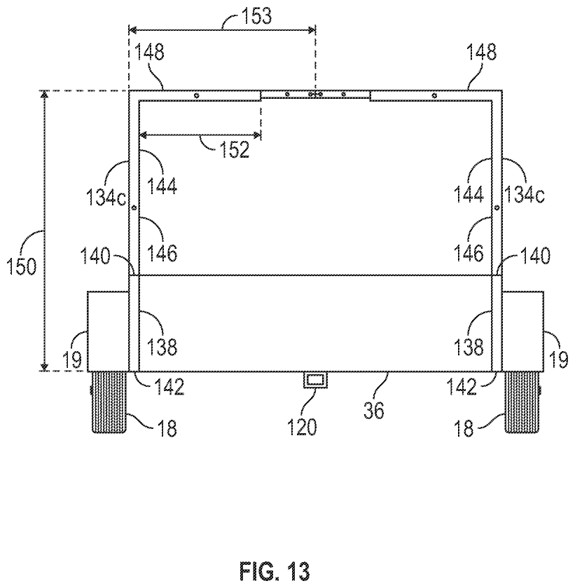

The sidewalls 30 and 32, trailer floor 34, front wall 33 and support members 54 may utilize any tie-down, track, mount or connector system to attach or incorporate accessories such as but not limited to bed platform(s), lighting system(s), table(s), chair(s), gear bag(s), sink(s), spare tire(s), bike rack(s), at any variety of locations and combinations. Further, a track rail support system for cots and/or bunk beds may be utilized. Also, there may be a receiver hitch 120 (see FIG. 13) at the loading end 36 of the trailer 12 for bike rack(s) and/or gear basket(s). Further, the sidewall 30 or 32 may incorporate or attach a receiver hitch (not shown) for a spare tire rack near the loading end 36 of the sidewall 30 or 32 as it abuts the trailer floor 34 inferiorly. The one or more additional receivers may also be used to support accessories, such as a camping table, or secure camping equipment and/or recreational equipment by securing such equipment to the receiver hitch with a lock. The trailer floor 34 may contain a permanent or removable connecting system to allow placement of a bench, stool, or chair. Further, the connecting system may allow for 360 degree rotation while seated. The trailer floor 34 may contain various combination(s) or location of connectors such as D-rings for tie downs and floor support.

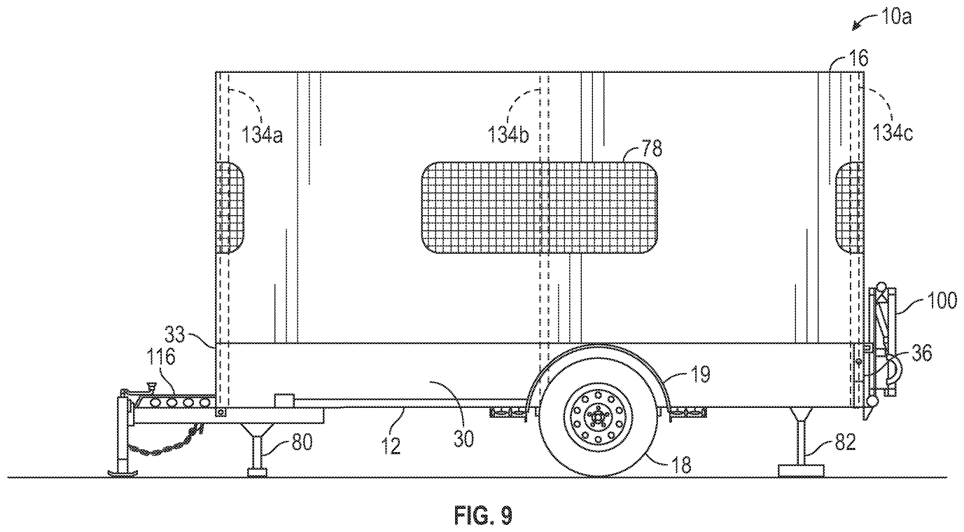

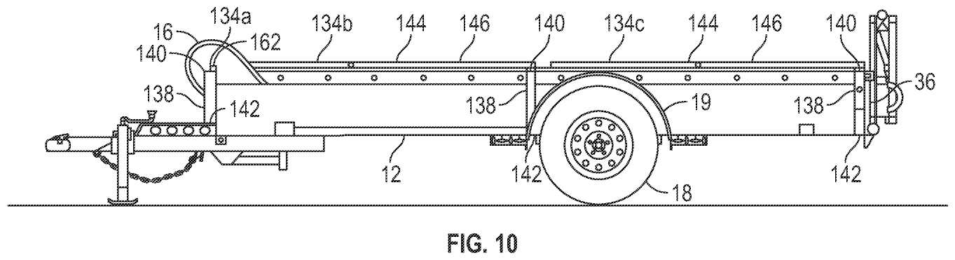

Shown in FIGS. 9 and 10 and designated by a reference numeral 10a is another embodiment of a combination tent and trailer assembly constructed in accordance with the present disclosure. The combination tent and trailer assembly 10a is similar in construction and function as the combination tent and trailer assembly 10 described above, with the exception that the combination tent and trailer assembly 10a has a support structure 130 that is different in construction as compared to the support structure 14. The combination tent and trailer assembly 10a according to the present disclosure includes the trailer 12, the support structure 130 connected to the trailer 12, and the canvas 16 attached to the support structure 130. The support structure 130 and the canvas 16 cooperate to form a shelter or tent over the trailer floor 34 of the trailer 12. When not in use, the support structure 130 and canvas 16 may be collapsed for travel and/or storage providing an open space for loading and unloading items onto and off of the trailer 12.

FIG. 9 shows the combination tent and trailer assembly 10a in an open or operable position. FIG. 10 shows the combination tent and trailer assembly 10a in the collapsed position.

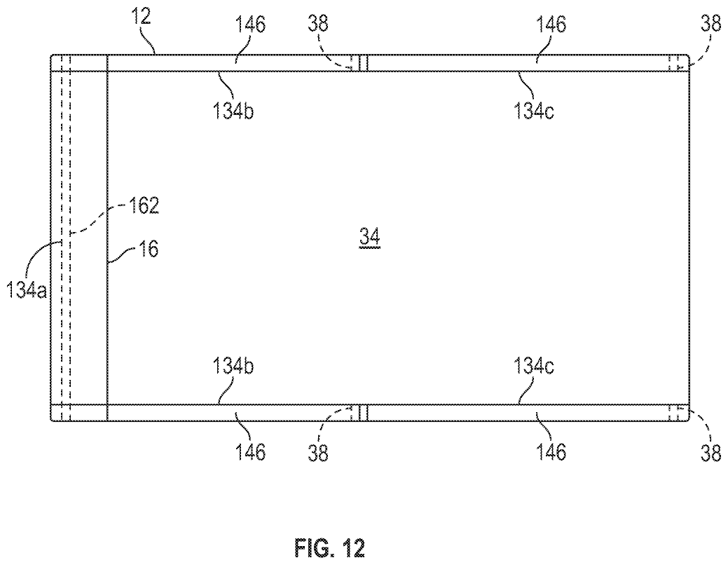

The support structure 130 includes a plurality of support members 134 that are collapsible and connected to discrete locations on the trailer 12. As shown in FIG. 9, the support structure 130 may be provided with three separate support members 134 which are designated in FIG. 9 with the reference numerals 134a, 134b, and 134c. In some embodiments, the support structure 130 may be provided with more than three support members 134. In one embodiment, the support members 134a, 134b, and 134c are U-shaped, extend across the trailer floor 34 (see FIG. 12) from the first sidewall 30 to the second sidewall 32 (see FIG. 13), and are connected to the trailer 12. For example the support members 134a, 134b and 134c may be removably connected to the first sidewall 30 and the second sidewall 32 so as to form a U-shaped frame above the trailer floor 34 of the trailer 12 when the support members 134a, 134b, and 134c are in the open or operable position. The support members 134a, 134b and 134c may be connected to the trailer 12 (e.g., the first sidewall 30 and the second sidewall 32) by any suitable assembly, such as bolts, screws, clamps, or the like.

For example, the support structure 130 may include a plurality of connectors 138 connected to the first sidewall 30 and the second sidewall 32. In the example shown, the support structure 130 is provided with six connectors 138 with three of the connectors 138 being connected to the first sidewall 30, and three connectors 138 being connected to the second sidewall 32. In this example, each of the support members 134a, 134b and 134c are connected to a pair of the connectors 138. Each pair of the connectors 138, in one embodiment, is positioned equidistant from the loading end 36 such that the support members 134a, 134b and 134c extend across the trailer floor 34 substantially perpendicular to the first sidewall 30 or the second sidewall 32. The support members 134b and 134c may be identical in construction and function. The connectors 138 may be tubular sleeves having an open upper end 140 and a stop 142. In this embodiment, the ends of the support members 134a, 134b and 134c may be sized and dimensioned to be positioned through the open upper end 140 and retained within the tubular sleeve by the stop 142. The stop 142 may extend across the entire interior of the tubular sleeve or only a portion of the interior of the tubular sleeve so long as the stop 142 engages the end of the support member 134a, 134b, or 134c and retains the support member 134a, 134b, or 134c within the tubular sleeve. In one non-limiting embodiment, the open upper end 140 is positioned approximately two (2) feet away from the stop 142. In the embodiment shown, the stop 142 is at a lower end of the connectors 138.

As shown in FIG. 13, the support members 134b and 134c are each formed of two tent deployment bars 144. The tent deployment bars 144 may be L-shaped members having a first leg 146 and a second leg 148. The second leg 148 may have a variable length. The first leg 146 may have a fixed length. The first leg 146 has a first length 150. The second leg 148 has a second length 152 in a collapsed position, and a third length 153 in an expanded position. In one embodiment, the first length 150 may be greater than the second length 152. The first length 150 and the second length 152 may vary depending upon the placement of the connectors 138, the number of support members 134, and the length or width of the trailer 12. In one non-limiting embodiment, in which the trailer 12 has a length between 12-13 feet, the first length 150 may be six feet, and the second length 152 may be two feet.

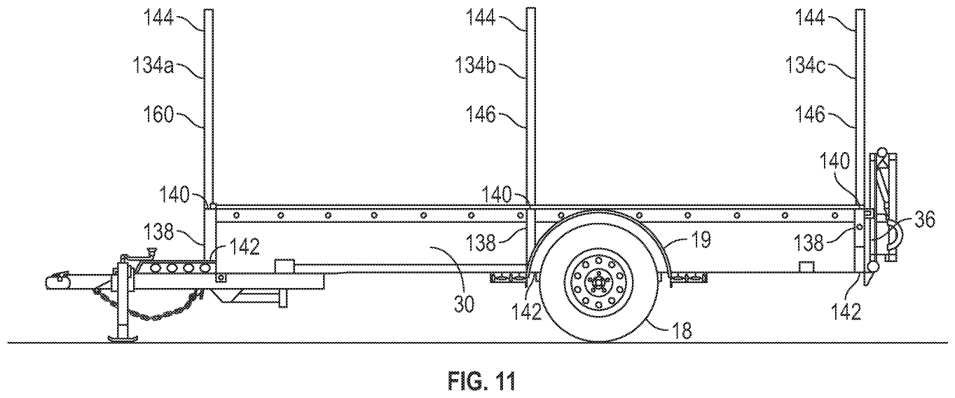

As will be discussed below, the support member 134a may be a U-shaped bar that has two side bars 160 and a top bar 162 extended between and connected to the side bars 160. The length of the side bars 160 may be variable so as to move from the collapsed position as shown in FIG. 10 to an extended position as shown in FIG. 11. In one embodiment, the length of the side bars 160 can be increased or decreased in a linear direction. The side bars 160 may be constructed of multiple linearly shaped pieces that are telescopingly positioned and connected together with retainers to selectively retain the multiple pieces in the extended position.

In the collapsed position, as shown in FIG. 10, the top bar 162 of the support member 134a is positioned adjacent to and about parallel to a top 166 of the front wall 33; the second legs 148 of the tent deployment bars 144 of the support members 134b and 134c are positioned within respective connectors 138; and the respective first legs 146 of the tent deployment bars 144 of the support members 134b and 134c extend above and are generally aligned (along the first length 150) with the respective first sidewall 30 or the respective second sidewall 32.

In the open or operable position as shown in FIG. 11, the side bars 160 of the support member 134a may be expanded to raise the top bar 162 relative to the front wall 33. The first legs 146 of the tent deployment bars 144 of the support member 134b may be positioned within respective connectors 138 such that the respective second legs 148 of the tent deployment bars 144 of the support member 134b extend over the trailer floor 34. In some embodiments, the second legs 148 of the tent deployment bars 144 of the support member 134b are colinear (see FIG. 13). Then, the second legs 148 of the tent deployment bars 144 of the support member 134b can be extended and connected together to form the support member 134b. Similarly, the first legs 146 of the tent deployment bars 144 of the support member 134c may be positioned within respective connectors 138 such that the respective second legs 148 of the tent deployment bars 144 of the support member 134c extend over the trailer floor 34. In some embodiments, the second legs 148 of the tent deployment bars 144 of the support member 134c are colinear (see FIG. 13). Then, the second legs 148 of the tent deployment bars 144 of the support member 134c can be connected together to form the support member 134c (see FIG. 13). In some embodiments, the second legs 148 of the tent deployment bars 144 are configured to have a variable length to assist in connecting the second legs 148 together when the first legs 146 are positioned within the connectors 138. In some embodiments, the second legs 148 may be constructed of multiple pieces that are telescopingly connected together with retainers to selectively retain the multiple pieces in the extended position.

When the support members 134a, 134b and 134c are in the collapsed position, the canvas 16 can be attached to and/or supported by the support member 134a as shown in FIG. 10. Prior to moving the support member 134a into the expanded or open position, the canvas 16 may be removed to permit the support member 134a to be moved to the expanded or open position. Thereafter, the canvas 16 can be positioned on the support members 134a, 134b, and 134c to form an enclosure as shown in FIG. 9. In some embodiments, the canvas 16 deploys from the support member 134a towards the support member 134c.

When the support members 134a, 134b, and 134c have a substantially U-shape, the canvas 16 is supported in a substantially rectangular shape above the trailer floor 34. It should be appreciated, however, that the support members 134a, 134b, and 134c may be formed of various lengths and shapes to support the canvas 16 in various shapes above the trailer floor 34.

From the above description, the inventive concepts disclosed are well adapted to carry out the objects and to attain the advantages mentioned and those inherent in the inventive concepts disclosed. While exemplary embodiments of the inventive concepts disclosed have been described for this disclosure, it will be understood that numerous changes may be made which will readily suggest themselves to those skilled in the art and which are accomplished within the scope and coverage of the inventive concepts disclosed.

1. A combination tent and trailer assembly, comprising:
a trailer having a first sidewall, a second sidewall, and a floor extending between the first sidewall and the second wall, the floor having a loading end and a hitching end, the trailer having a hitch at the hitching end;
a support structure connected to the first sidewall and the second sidewall, the support structure comprising:
a first support base positioned on the first sidewall;
a second support base positioned on the second side wall; and
a plurality of support members extending from the first support base to the second support base; and
a canvas attached to the plurality of support members,
wherein the plurality of support members are movable between a collapsed position adjacent the hitching end to provide a loading space at the loading end, and an open position where the plurality of support members are in a spaced apart relationship to support the canvas and form an enclosure over the floor of the trailer.

2. The combination tent and trailer assembly of claim 1, wherein the plurality of support members includes a first support member, a second support member, and third support member positioned between the first support member and the third support member, each of the first, second, and third support members having a length, wherein the length of first support member is equal to the length of the second support member and the length of the third support member is less than the length of the first support member and the second support member so that the canvas is supported in a substantially rectangular shape above the trailer floor.

3. The combination tent and trailer assembly of claim 1, wherein the plurality of support members includes a first support member, a second support member, and third support member, each of the first, second, and third support members having equal lengths so that the canvas is supported in a substantially semi-spherical shape above the trailer floor.

4. The combination tent and trailer assembly of claim 1, wherein the canvas includes a plurality of slots for receiving each of the plurality of support members.

5. The combination tent and trailer assembly of claim 1, further comprising:
a jack extending from the floor of the trailer and towards a ground surface, the jack positioned near the loading end.

6. The combination tent and trailer assembly of claim 1, further comprising:
a jack extending from the floor of the trailer and towards a ground surface, the jack positioned near the hitching end.

7. The combination tent and trailer assembly of claim 1, further comprising:
a ramp extending from the loading end of the trailer, the ramp movable between a storage position and an operable position where the ramp is supported by stabilizing member extending from the ramp towards a ground surface to provide a porch surface.

8. The combination tent and trailer assembly of claim 7, further comprising:
a plurality of rods extending from the porch surface; and
a canopy extending from the canvas, the canopy supported by the rods to provide a cover over the porch surface.

9. The combination tent and trailer assembly of claim 8, further comprising:
a step extending from the ramp to provide access to the porch.

10. The combination tent and trailer assembly of claim 1, further comprising:
a shelf extending from the hitching end and moveable between a storage position and an open position for supporting an air conditioning unit.

11. The combination tent and trailer assembly of claim 1, further comprising:
a rack extending from the hitching end for storage.

12. A method of forming a combination tent and trailer assembly, comprising:
obtaining a trailer having a first sidewall, a second sidewall, and a floor extending between the first sidewall and the second wall, the floor having a loading end and a hitching end;
connecting a support structure to the first sidewall and the second sidewall, the support structure comprising:
a first support base adjacent to the first sidewall;
a second support base adjacent to the second side wall; and
a plurality of support members extending from the first support base to the second support base; and
attaching a canvas to the plurality of support members.

13. The method of forming the combination tent and trailer assembly of claim 12 wherein the plurality of support members are movable between a collapsed position adjacent to the hitching end to provide a loading space at the loading end, and an open position where the plurality of support members are in a spaced apart relationship to support the canvas and form an enclosure over the floor of the trailer.

14. The method of claim 12, wherein the plurality of support members includes a first support member, a second support member, and a third support member positioned between the first support member and the third support member, each of the first, second, and third support members having a length, wherein the length of the first support member is equal to the length of the second support member and the length of the third support member is less than the length of the first support member and the second support member so that the canvas is supported in a substantially rectangular shape above the trailer floor.

15. The method of claim 12, wherein the plurality of support members includes a first support member, a second support member, and third support member, each of the first, second, and third support members having equal lengths so that the canvas is supported in a substantially semi-spherical shape above the trailer floor.

16. The method of claim 12, wherein the canvas includes a plurality of slots for receiving each of the plurality of support members.

17. The method of claim 12, further comprising:
connecting a jack to the floor of the trailer near the loading end.

18-27. (canceled)

28. A combination tent and trailer assembly, comprising:
a trailer having a first sidewall, a second sidewall, and a floor extending between the first sidewall and the second wall, the floor having a loading end and a hitching end, the trailer having a hitch;
a support structure adjacent to the first sidewall and the second sidewall, the support structure comprising:
a first support base positioned adjacent to the first sidewall;
a second support base positioned adjacent to the second side wall; and
a plurality of support members extending from the first support base to the second support base; and
a canvas attached to the plurality of support members,
wherein the plurality of support members are movable between a collapsed position adjacent to the hitching end to provide a loading space at the loading end, and an open position where the plurality of support members are in a spaced apart relationship to support the canvas and form an enclosure over the floor of the trailer.

29-30. (canceled)

31. The combination tent and trailer assembly of claim 28, wherein the canvas includes a plurality of slots for receiving each of the plurality of support members.

32-33. (canceled)

34. The combination tent and trailer assembly of claim 28, further comprising:
a ramp extending from the loading end of the trailer, the ramp movable between a storage position and an operable position where the ramp is supported by stabilizing member extending from the ramp towards a ground surface to provide a porch surface.

35-38. (canceled)
